(19) United States
(12) Patent Application Publication
(10) Pub. No.: US 2026/0297479 A1
(43) Pub. Date: Oct. 1, 2026

(54) VINEGAR WITH NATURAL SWEETENER AND PRODUCTION METHOD THEREOF

(71) Applicants: Ignacio Roig Lorenzo, Falset Tarragona (ES); Emilio Roig Pedrola, Falset Tarragona (ES); Josep Roig Pedrola, Falset Tarragona (ES)

(72) Inventors: Ignacio Roig Lorenzo, Falset Tarragona (ES); Emilio Roig Pedrola, Falset Tarragona (ES); Josep Roig Pedrola, Falset Tarragona (ES)

(21) Appl. No.: 19/480,935

(22) PCT Filed: Apr. 12, 2024
(86) PCT No.: PCT/ES2024/070221

§ 371 Date: Nov. 3, 2025

(30) Foreign Application Priority Data
May 4, 2023 (ES) U202330777
Oct. 23, 2025 (ES) P202530975

(51) Int. Cl. C12J 1/08; A23L 27/14; C12J 1/02

(52) U.S. Cl. CPC C12J 1/08; A23L 27/14; C12J 1/02

(57) ABSTRACT

A vinegar with a natural sweetener, obtained from a mixture of wine vinegar and natural Stevia rebaudiana Bertoni leaves in a proportion between 20 and 30 g/L, resulting in a complex matrix containing chlorophyll, phenolic compounds, flavonoids, minerals and fibres. The product exhibits a characteristic physicochemical profile with energy values of ≥81.4 KJ/100 mL, acetic acid ≥0.26 g/L, alcohol content ≥2% vol, and acidity≤8.15%, together with an organoleptic profile balanced in acidity, sweetness and bitterness. A method for obtaining the product based on maturing the mixture in oak barrels under controlled temperature (20-40° C.), during which a bacterial film (“mother of vinegar”) is formed, until a cured vinegar with a stable organoleptic profile is obtained. During successive refilling operations, Stevia rebaudiana Bertoni leaves or a concentrate obtained by intensive maceration are added again, in order to maintain the flavour intensity and stability of the final product.

### OBJECT OF THE INVENTION

The object of the present specification is a vinegar with a natural sweetener, specifically with Stevia rebaudiana Bertoni, which allows the development of a product with new characteristic flavour notes (sweet-and-sour with a touch of bitterness, in a proportion very attractive for use as a food additive), combined with the absence of added sugars, thereby providing better nutritional qualities than other vinegar-based condiments or sauces.

The special flavour of the product herein proposed, and its distinctive sensory qualities, allow it to be used both as a dressing for foods (such as salads or similar) and as a base for sauces or other culinary applications, whether in domestic use or in catering establishments.

### BACKGROUND OF THE INVENTION

Vinegar has been used since ancient times (the etymology of its name refers to a sour wine), obtained by fermentation and used, as already mentioned, as a condiment, dressing, or for other purposes to impart flavour to meats and/or vegetables (and may also be used as a preservative agent for a wide range of products).

Vinegar is obtained in a second fermentation of grapes, since in the first fermentation, the sugars in the grape must are converted into ethanol (resulting in wine), and in the second fermentation, oxidation of the ethanol occurs (through the action of a wide group of Acetobacter species that combine oxygen with alcohol), which ultimately produces vinegar.

The use of sweeteners in vinegars is described in prior literature and patent documents. Compositions are known that incorporate non-natural sweeteners such as purified Stevia extract, a common artificial sweetener known as additive E-960, which contains purified steviol glycosides that confer an intense and clean sweetness without providing additional nuances.

Examples of such compositions are described in documents US2016257917, which discloses a health beverage composed of apple cider vinegar, tea, and Stevia in the form of a purified extract. The purpose is to sweeten the beverage, reducing the acidity and sourness of the vinegar without adding calories and without altering the product's health properties; and CN102021108A, which describes a sweet millet vinegar composition in which Stevia appears in the form of a refined powdered Stevia extract—a standardised preparation rich in steviol glycosides—with the aim of sweetening the product and softening its acidity, thereby providing a more pleasant taste profile.

The objective technical problem addressed by the invention is to provide a vinegar sweetened with natural products that offers a novel and distinctive sensory profile compared with vinegar artificially sweetened with the E-960 additive, composed of purified steviol glycosides.

The present invention constitutes a further development of international application PCT/ES2024/070221, owned by the same applicant, in which a vinegar with a natural sweetener based on Stevia rebaudiana Bertoni leaves was described. It also incorporates improvements and additional features disclosed in Spanish application P202530975, filed subsequently by the same applicant, which introduces new subject matter not contained in the earlier PCT application.

The combination of both priorities serves as the basis for the present European application, which consolidates and expands the technical scope of the product and method described herein.

### DESCRIPTION OF THE INVENTION

The technical problem solved by the present invention is to achieve a vinegar with a new characteristic flavour in terms of sweetness, bitterness, and acidity, without added sugars, based on natural sweeteners.

To that end, the invention proposes a vinegar with a natural sweetener comprising a mixture of wine or wine vinegar and natural Stevia rebaudiana Bertoni leaves, in a proportion between 20 and 30 grams of natural Stevia rebaudiana Bertoni leaves per litre of wine or wine vinegar, which gives rise to a complex matrix containing chlorophyll, phenolic compounds, flavonoids, minerals, and fibres.

Owing to its composition, the present invention provides organoleptic qualities that make it novel within the sector of vinegars, dressings and/or vinegar-based sauces, and it differs from other products in the same technical field, such as balsamic vinegar creams that ideally incorporate “Stevia” derived from “Stevioside” and “Rebaudioside”, i.e., purified steviol glycosides E-960, which are considered non-natural products under European legislation (since the glycoside extraction process means they are not regarded as natural).

Therefore, it would not be considered obvious to a person skilled in the art to include such products in a vinegar made from natural raw materials, since any expert would be aware of their non-natural origin.

Another aspect of the invention relates to a method for obtaining a vinegar sweetened with Stevia rebaudiana Bertoni leaves, which optimises the extraction of the soluble active principles from the Stevia rebaudiana Bertoni leaves.

In a first practical embodiment, the vinegar is obtained by a process of filling oak barrels (or other wood) by mixing wine together with Stevia rebaudiana Bertoni leaves, or the vinegar itself together with Stevia rebaudiana Bertoni leaves (depending on the amount of Stevia rebaudiana Bertoni leaves, a greater or lesser flavour intensity will be obtained), until the barrel is filled to three quarters of its capacity, using a proportion of between twenty and thirty grams of Stevia rebaudiana Bertoni per litre of vinegar.

On the surface of the liquid, a film known as the “mother of vinegar” will form, composed of the bacteria responsible for the acetic fermentation.

Subsequently, the barrel is gradually emptied of the obtained product while being refilled with wine or vinegar.

The duration of the process depends largely on the temperature of the liquid. The optimum temperature ranges between 20° C. and 40° C., with a preferred temperature of 30° C.

In alternative embodiments, each time the raw materials are renewed for obtaining the vinegar—either by adding wine or vinegar into the barrels—, Stevia rebaudiana Bertoni leaves (in green or dried form) are added again in the same indicated proportion, in order to maintain the concentration and stability of the characteristic organoleptic profile.

In an additional embodiment, when matured vinegar is available, an intensive maceration may be carried out by filling the barrels with said matured vinegar and a high quantity of Stevia rebaudiana Bertoni leaves greater than 30 g/L, so that the resulting liquid becomes saturated with the characteristic flavour of Stevia. The concentrated product thus obtained is subsequently diluted with cured vinegar until the desired flavour balance is achieved.

The vinegar obtained according to the invention presents the following physicochemical values:
Energy value: ≥81.4 KJ/100 mL
Caloric value: ≥19.5 kcal/100 mL
Acetic acid: ≥0.26 g/L
D-Glucose+D-Fructose: ≥1.8 g/L
Alcohol content: ≥2% vol.
pH: ≥2.94
Acidity degree: ≤8.15%
and it presents a complex organoleptic profile, distinguishable from vinegars sweetened with E-960, with the following characteristics.

Visual appearance: deep brown colour with mahogany tones. Clear, limpid and bright, without visible sediments. Noticeable viscosity.

Olfactory aspect: Classic profile, dominated by pronounced acetic aromas and a clear ethyl acetate note, of high yet balanced intensity. Slight secondary notes of ripe fruit can be perceived, providing a degree of complexity. Identified aromas include: dried fig, cured dairy, ethyl acetate, molasses, undergrowth, nuts, sweet pear, peach, hay, tobacco leaf.

Gustatory aspect: Strongly acidic entry, dominated by acetic/acetate character, balanced by moderate residual sweetness. Medium body, fluid texture, slight astringency, and perceptible mild bitterness. Medium-to-high persistence, with predominance of acetic character.

As a result of its distinctive flavor, the vinegar proposed herein may be served as a dressing, as has traditionally been done in salads (the main destination of vinegar since ancient times), and also as a base for new dishes seeking a more characteristic taste, that is, as a foundation for innovation within the culinary field, a growing technical sector.

The vinegar according to the invention may also be obtained through more industrialized and well-known processes in the technical field, such as the “German method” and/or the “submerged or Frings method”, although the resulting vinegar will have fewer organoleptic nuances.

### PREFERRED EMBODIMENT OF THE INVENTION

The vinegar with natural sweetener proposed herein is characterised by being composed of a mixture of one litre of wine vinegar combined with between twenty and thirty grams of Stevia Rebaudiana Bertoni leaves.

In a first practical embodiment, the Stevia Rebaudiana Bertoni is provided in the mixture in the form of green leaves.

In a second practical embodiment, the Stevia Rebaudiana Bertoni is provided in the mixture in the form of dried leaves.

The method for obtaining the vinegar with natural sweetener described herein is characterised by comprising a first stage of filling oak barrels (or other equivalent wood) by mixing wine vinegar (or wine) together with Stevia rebaudiana Bertoni leaves, until the barrel is filled to three quarters of its capacity, with a proportion of between twenty and thirty grams of Stevia rebaudiana Bertoni per litre of vinegar; a second stage of forming a film known as the “mother of vinegar” composed of the bacteria responsible for acetic fermentation; and a third stage of emptying the product and refilling with wine or vinegar, all carried out at a constant temperature between 20° C. and 40° C., with a preferred temperature of 30° C.

In an alternative embodiment of the method, Stevia rebaudiana Bertoni leaves may be added again at each partial renewal of the barrel contents, thus ensuring continuous and homogeneous extraction of the active compounds of the plant.

In another embodiment, the process may consist of macerating Stevia rebaudiana Bertoni leaves in previously matured vinegar that is free of alcohol content, using quantities greater than 30 g/L of natural leaves, thereby obtaining a liquid concentrated in aromatic and flavour compounds, which can later be blended with already cured vinegar until the desired sensory profile is achieved.

The sweetened vinegar with Stevia rebaudiana Bertoni thus obtained presents the following physicochemical values:
Energy value: 146.4 KJ/100 mL
Caloric value: 35 kcal/100 mL
Acetic acid: 0.58 g/L
D-Glucose+D-Fructose: 2.3 g/L
Alcohol content: 3.83% vol.
pH: 3.16
Acidity degree: 5.78%

To characterize the organoleptic properties of the obtained vinegar, a descriptive sensory analysis was carried out following standard methodology, by a panel composed of six specialized tasters from the Parc Tecnològic del Vi (VITEC).

The analysis was performed using a discontinuous categorical sensory scale from 0 to 7, in which each value corresponds to a specific level of perceived intensity, without intermediate scores being allowed. This scale is not continuous but ordinal, and is interpreted as follows:

### Value/Approximate Meaning

0—Absence of attribute
1—Very weak
2—Weak
3—Light/perceptible
4—Medium
5—Medium-high
6—High
7—Very high/maximum

Each taster independently rated the intensity of the different visual, olfactory and gustatory attributes of the product. The results are expressed as the median of the set of individual assessments, in order to represent the central value of collective perception and to avoid the influence of extreme observations.

### Results of the Sensory Test (Discontinuous Scale 0-7):

### Visual Aspect

Colour tone: 5 (mahogany-brown)
Colour intensity: 3 (medium layer)
Limpidity: 6 (clear and bright)
Visual viscosity: 3 (noticeable viscosity)
Olfactory aspect
Overall aromatic intensity: 5.5
Fresh fruit: 2
Dried/candied fruit: 3
Acetic: 3
Ethyl acetate: 5.5
Caramel: 3
Spice: 2
Balsamic: 4
Vegetal: 3
Wood: 0
Dairy: 1
Gustatory aspect
Acidity: 7
Acetic sharpness: 5.5
Viscosity: 3
Sweetness: 2
Bitterness: 1
Persistence: 6
Astringency: 1
Body/volume: 4

The sensory profile obtained confirms a vinegar of marked acetic identity, with high and persistent acidity, balanced by moderate residual sweetness contributed by the natural Stevia rebaudiana Bertoni leaf. The olfactory perception combines the classic character of matured vinegar (acetic and ethylic) with natural nuances of dried fruit, molasses and vegetal notes, which are absent in vinegars sweetened with purified steviol glycosides (E-960).

The overall result demonstrates a product with a complex organoleptic balance, in which natural Stevia acts not merely as a sweetener but also as a generator of a rounder, softer, and more structured aromatic profile.

1. A vinegar with natural sweetener comprising a mixture of wine vinegar and natural leaves of Stevia rebaudiana Bertoni, in a proportion between 20 and 30 grams of leaf per litre of wine vinegar.

2. The vinegar with natural sweetener according to claim 1, wherein the Stevia rebaudiana Bertoni leaves are green leaves.

3. The vinegar with natural sweetener according to claim 1, wherein the Stevia rebaudiana Bertoni leaves are dried leaves.

4. The vinegar with natural sweetener according to claim 1, wherewith the vinegar with natural sweetener has an energy value equal to or greater than 81.4 KJ/100 mL and a caloric value equal to or greater than 19.5 kcal/100 mL.

5. The vinegar with natural sweetener according to claim 1, it wherein the vinegar with natural sweetener has a value equal to or greater than 0.26 g/L of acetic acid and a value equal to or greater than 1.8 g/L of D-Glucose+D-Fructose.

6. The vinegar with natural sweetener according to claim 1, it wherein the vinegar with natural sweetener has an acquired alcoholic strength equal to or greater than 2% vol.

7. The vinegar with natural sweetener according to claim 1, the vinegar with natural sweetener has a pH equal to or greater than 2.94 and an acidity degree equal to or less than 8.15%.

8. The vinegar according to claim 1, wherein the vinegar with natural sweetener has a complex matrix containing chlorophyll, phenolic compounds, flavonoids, minerals and fibres derived from the natural leaf of Stevia rebaudiana Bertoni.

9. The vinegar according to claim 1, wherein the vinegar with natural sweetener has an organoleptic profile having:
a visual profile: intense brown colour with mahogany tones, clear, limpid and bright, without visible sediments, and noticeable viscosity-;
an aromatic profile: classic, with predominance of strong acetic aromas and clear ethyl acetate notes, of high but balanced intensity, slight secondary notes of ripe fruit are perceived, providing a certain complexity, identified aromas include: dried fig, cured dairy, ethyl acetate, molasses, undergrowth, nuts, sweet pear, peach, hay, tobacco leaf; and
a gustatory profile: showing in mouth a predominant acidity of acetic/acetate character, balanced by moderate residual sweetness, medium body, fluid texture, slight astringency, slight perceptible bitterness, and medium-high persistence, with predominance of acetic character.

10. A method for obtaining the product according to claim 1, the method comprising the steps of:
I. a first stage of filling oak barrels (or other equivalent wood) by mixing wine vinegar with Stevia rebaudiana Bertoni leaves, until the barrel is filled to three quarters of its capacity, with a proportion of between twenty and thirty grams of Stevia rebaudiana Bertoni per litre of vinegar;
II. a second stage of forming a film known as the “mother of vinegar”, composed of the bacteria responsible for acetic fermentation; and
III. a third stage of emptying the product and refilling with wine or vinegar; all performed at a constant temperature between 20° C. and 40° C.
IV.

11. The method according to claim 10, wherein the third stage, of emptying the product and refilling with wine or vinegar, Stevia rebaudiana Bertoni leaves are added again in an equivalent proportion, in order to maintain the flavour intensity.

12. The method according to claim 10, wherein in the third stage, of emptying the product and refilling with wine or vinegar, a concentrate obtained from the intensive maceration of matured vinegar with a quantity of Stevia rebaudiana Bertoni leaves greater than 30 g/L is incorporated, said concentrate being subsequently diluted with cured vinegar until the desired flavour is achieved.
